(19) United States
(12) Patent Application Publication
(10) Pub. No.: US 2009/0210311 A1
(43) Pub. Date: Aug. 20, 2009

(54) METHOD AND A SYSTEM FOR CENTRALIZING ELECTRONIC ACTIVITIES ASSOCIATED WITH A GOOD OF INTEREST OVER A DATA NETWORK

(76) Inventor: Jean Dobey Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/031,808

(22) Filed: Feb. 15, 2008

(51) Int. Cl. G06Q 30/00

(52) U.S. Cl. 705/26

(57) ABSTRACT

There is provided a method for centralizing electronic activities associated with a good of interest over a data network, the method comprising providing a user interface connected to the data network; enabling a participant to locate over the data network a good of interest in accordance with good search criteria defined thereby using the user interface; enabling the participant to authenticate the good of interest; enabling the participant to remotely and interactively communicate with at least one other participant over the data network and to remotely and interactively share information therewith about the selected good of interest using the user interface; and enabling the participant to carry out trading activities in connection with the good of interest. There is further provided a system for centralizing electronic activities associated with a good of interest over a data network and a method for concluding a commercial transaction over a data network. The participant is preferably a prospective purchaser, a provider, a carrier or a manufacturer of the good.

### FIELD OF THE INVENTION

The present invention relates generally to the field of electronic activities, and more specifically to a method and a system for centralizing electronic activities associated with a good of interest over a data network.

### BACKGROUND OF THE INVENTION

As electronic commerce evolves, the Internet is becoming an indispensable tool for consumers when searching, purchasing and browsing goods and services.

Traditionally, while searching for an item or a service, a consumer would visit various electronic market Web sites and conduct various searches in order to locate an item or a service of interest. Besides, when purchasing various items originating from various electronic market Web sites, a consumer would need to carry out a distinct purchase process on each one of the electronic market Web sites where an item has been purchased.

Moreover, in order to authenticate a given item of interest, traditionally, a consumer would need to conduct a distinct authenticity process outside the frame of the Web site on which the item is being purchased, which implies communicating with a prospective provider of the item using another medium. This process is independent of the purchase process and implies postpone of the purchase process until an authenticity of the item is confirmed by the third-party.

Similarly, in order to obtain a custom quote for a given item of interest, traditionally, the consumer would need to conduct a distinct and independent process outside the frame of the Web site on which the item is being purchased, which implies communicating with a third party (ex. the custom authorities) and providing a description of the item of interest for which a custom quote is required.

Moreover, traditionally, the online consumer is not able to obtain any advice or ideas from others unless they are physically next to him/her or communicate using conventional methods (i.e email, telephone, etc.). Again, the consumer would need to conduct a distinct and independent process outside the frame of the Web site on which the item is being purchased.

### SUMMARY OF THE INVENTION

It is therefore an object of the present invention to provide methods and systems for centralizing electronic activities associated with a good of interest over a data network that overcome the above drawbacks.

As a first aspect of the invention there is provided a method for centralizing electronic activities associated with a good of interest over a data network, the method comprising:
providing a user interface connected to the data network;
enabling a participant to locate over the data network a good of interest in accordance with good search criteria defined thereby using the user interface;
enabling the participant to authenticate the good of interest;
enabling the participant to obtain over the data network a shipping service of interest to ship the good of interest in accordance with shipping service criteria defined thereby using the user interface;
enabling the participant to remotely and interactively communicate with at least one other participant over the data network and to remotely and interactively share information therewith about the selected good of interest; and
enabling the participant to carry out trade activities in connection with the good of interest using the user interface.

The enabling steps of the method can be carried out interchangeably.

The enabling a participant to locate over the data network a good of interest preferably comprises using the data network for accessing and inquiring electronic market databases storing data corresponding to a list of goods.

The data network preferably comprises the Internet and the electronic market databases comprise electronic market Web sites connected to the Internet.

The participant can be a prospective purchaser of the good of interest and the enabling the participant to carry out trade activities comprises enabling the participant to carry out at least one of reviewing trade activities related information, placing a barter offer, placing a purchase offer, placing a bid offer, concluding a barter transaction, concluding a purchase transaction and concluding a bid transaction.

Preferably, the enabling the prospective purchaser to authenticate the good of interest comprises accessing and inquiring an authentication database to ensure that the good of interest originates from an authorized provider.

Preferably, the authentication database comprises, for each one of a plurality of goods, an identifier for uniquely identifying the good and at least one corresponding authorized good provider, wherein the inquiring comprises sending an inquiring request to the authentication database comprising the unique identification code and receiving thereof an indication of a successful authentication if a prospective provider corresponding to the unique identification code is comprised in the database.

Preferably, the enabling the participant to remotely and interactively communicate with at least one other participant over the data network comprises displaying the good of interest in a screen interface displayed to the participant, enabling the at least one other participant to access the screen interface displayed to the participant via the data network, and enabling the at least one other participant to interactively communicate with the participant via the screen interface using the data network.

The method preferably further comprises:
enabling the participant to search over the data network a shipping service of interest to ship the good of interest in accordance with shipping service criteria defined thereby using the user interface; and
enabling the participant to conclude a shipping service transaction to purchase the shipping service of interest using the user interface.

Preferably, the enabling the participant to search over the data network a shipping service of interest to ship the good of interest comprises using the data network for accessing and inquiring shipping service databases.

The shipping service databases preferably comprise shipping service Web sites connected to the Internet.

The method preferably further comprises enabling the participant to carry out an electronic payment using the user interface.

The participant can also be a prospective provider of the good of interest and the enabling the participant to carry out trade activities comprises enabling the participant to carry out at least one of posting the good for barter, posting the good for sale, posting the good for bid, concluding a barter transaction, concluding a purchase transaction and concluding a bid transaction.

Preferably, the enabling the prospective provider to authenticate the good of interest comprises enabling the prospective provider to prove that he is an authorized provider of the good.

Preferably, the enabling the participant to remotely and interactively communicate with at least one other participant over the data network comprises displaying the good of interest in a screen interface displayed to the participant, enabling the at least one other participant to access the screen interface displayed to the participant via the data network, and enabling the at least one other participant to interactively communicate with the participant via the screen interface using the data network.

The method preferably further comprises:
enabling the participant to search over the data network a shipping service of interest to ship the good of interest in accordance with shipping service criteria defined thereby using the user interface; and
enabling the participant to conclude a shipping service transaction to purchase the shipping service of interest using the user interface.

Preferably, the enabling the participant to search over the data network a shipping service of interest to ship the good of interest comprises using the data network for accessing and inquiring shipping service databases.

Preferably, the shipping service databases comprise shipping service Web sites connected to the Internet.

The method preferably further comprises enabling the participant to carry out an electronic payment using the user interface.

The participant can also be a carrier and the enabling the participant to carry out trade activities comprises enabling the carrier to carry out at least one of posting a shipping service offer to ship the good of interest and concluding a shipping service transaction to ship the good of interest.

Preferably, the enabling the carrier to authenticate the good of interest comprises accessing and inquiring a jurisdictional database for retrieving jurisdictional information in order to inquire about legal aspects with respect to shipping the good of interest.

Preferably, the enabling the participant to remotely and interactively communicate with at least one other participant over the data network comprises displaying the good of interest in a screen interface displayed to the participant, enabling the at least one other participant to access the screen interface displayed to the participant via the data network, and enabling the at least one other participant to interactively communicate with the participant via the screen interface using the data network.

The method preferably further comprises enabling the participant to carry out an electronic payment using the user interface.

The participant can also be a manufacturer of the good of interest and the process of enabling the participant to authenticate the good of interest and the process of enabling the manufacturer to carry out trade activities comprises enabling the manufacturer to certify that the good of interest has been manufactured thereby.

Preferably, the enabling the participant to remotely and interactively communicate with at least one other participant over the data network comprises displaying the good of interest in a screen interface displayed to the participant, enabling the at least one other participant to access the screen interface displayed to the participant via the data network, and enabling the at least one other participant to interactively communicate with the participant via the screen interface using the data network.

The method preferably further comprises enabling the participant to carry out an electronic payment using the user interface.

As a further aspect of the invention, there is provided a system for centralizing electronic activities associated with a good of interest over a data network, the system comprising:
a user interface connected to the data network;
a search engine connected to the user interface and to the data network, the search engine comprising a good search unit for enabling a participant to locate over the data network a good of interest in accordance with good search criteria defined thereby using the user interface;
an anti-counterfeit engine connected to an authentication database for enabling the participant to authenticate the good of interest;
a community engine connected to the data network for enabling the participant to remotely and interactively communicate with at least one other participant over the data network and to remotely and interactively share information therewith about the good of interest; and
an e-commerce engine connected to the user interface and to the data network for enabling the participant to carry out trade activities in connection with the good of interest.

Preferably, the search engine further comprises a shipping service search unit for enabling the participant to search over the data network a shipping service of interest to ship the good of interest in accordance with shipping service criteria defined thereby using the user interface, and the e-commerce engine further comprises a shipping service purchase unit for enabling the participant to conclude a shipping service transaction to purchase the shipping service of interest.

Preferably, the e-commerce engine comprises at least one of an information reviewing unit, a bartering unit, a bidding unit and a purchase unit.

The participant can be a prospective purchaser of the good of interest and the information reviewing unit enables the participant to review trade activities related information in connection with the good of interest, the bartering unit enables the participant to place a barter offer and to conclude a barter transaction in connection with the good of interest, the bidding unit enables the participant to place a bid offer and to conclude a bid transaction in connection with the good of interest, and the purchase unit enables the participant to place a purchase offer and to conclude a purchase transaction in connection with the good of interest.

The system preferably further comprises a mediator server connected to the data network; wherein the engines run on the mediator server.

Preferably, the mediator server comprises a mediator Web site and the user interface is connected to the mediator Web site.

The system preferably further comprises a mediator database storing data corresponding to a list of goods and services offered for trade, wherein the mediator database is connected to the search engine.

Preferably, the anti-counterfeit engine is adapted to be connected, via the data network, to a database comprising, for each one of a plurality of goods, an identifier for uniquely identifying the good and at least one corresponding authorized good provider, wherein the authenticating comprises sending an inquiring request to the authentication database comprising a unique identification code associated with the good of interest and receiving thereof an indication of a successful authentication if a prospective provider corresponding to the unique identification code is found in the database.

Preferably, the mediator Web site comprises a live shopping interface connected to the community engine for displaying to the participant the good of interest, and for enabling the at least one other participant to access the interface displayed to the participant via the data network and to interactively communicate with the participant using the data network.

The e-commerce engine preferably further comprises an electronic payment unit for enabling the participant to carry out electronic payments to purchase the good of interest and the shipping service of interest.

The participant can be a prospective provider of the good of interest and the bartering unit enables the participant to post the good for barter and to conclude a barter transaction in connection with the good of interest, the purchase unit enables the participant to post the good for sale and to conclude a purchase transaction, the bidding unit enables the participant to post the good for bid and to conclude a bid transaction.

The system preferably further comprises a mediator server connected to the data network; wherein the engines run on the mediator server.

The mediator server preferably comprises a mediator Web site and the user interface is connected to the mediator Web site.

The system preferably further comprises a mediator database storing data corresponding to a list of goods and services offered for trade, wherein the mediator database is connected to the search engine.

Preferably, the mediator Web site comprises a live shopping interface connected to the community engine for displaying to the participant the good of interest, and for enabling the at least one other participant to access the interface displayed to the participant via the data network and to interactively communicate with the participant using the data network.

The e-commerce engine preferably further comprises an electronic payment unit for enabling the participant to carry out electronic payments to purchase the good of interest and the shipping service of interest.

As a further aspect of the invention, there is provided a method for concluding a commercial transaction over a data network, the method comprising:
using a mediator for locating a good of interest over the data network according to good search criteria defined by a participant over the data network;
automatically authenticating by the mediator the good of interest;
using the mediator for remotely and interactively communicating with at least one other participant over the data network to share information therewith about the good of interest; and
using the mediator for concluding a commercial transaction to purchase the good of interest.

The method preferably further comprises:
using the mediator for obtaining a shipping service of interest to ship the good of interest; and
using the mediator for concluding a shipping transaction to purchase the shipping service of interest.

The method preferably further comprises using the mediator for enabling the participant to carry out electronic payments to purchase the good of interest and the shipping service of interest.

The steps of the method can be carried out interchangeably.

### BRIEF DESCRIPTION OF THE DRAWINGS

Further features and advantages of the present invention will become apparent from the following detailed description, taken in combination with the appended drawings, in which:

FIG. 1 is a flow chart showing an embodiment of a method for centralizing electronic activities associated with a good of interest over a data network; and

FIG. 2 is a block diagram showing an embodiment of a system for centralizing electronic activities associated with a good of interest over a data network;

FIG. 3 is a flow chart showing an embodiment of a method for facilitating concluding commercial transactions over a data network.

### DETAILED DESCRIPTION OF THE INVENTION

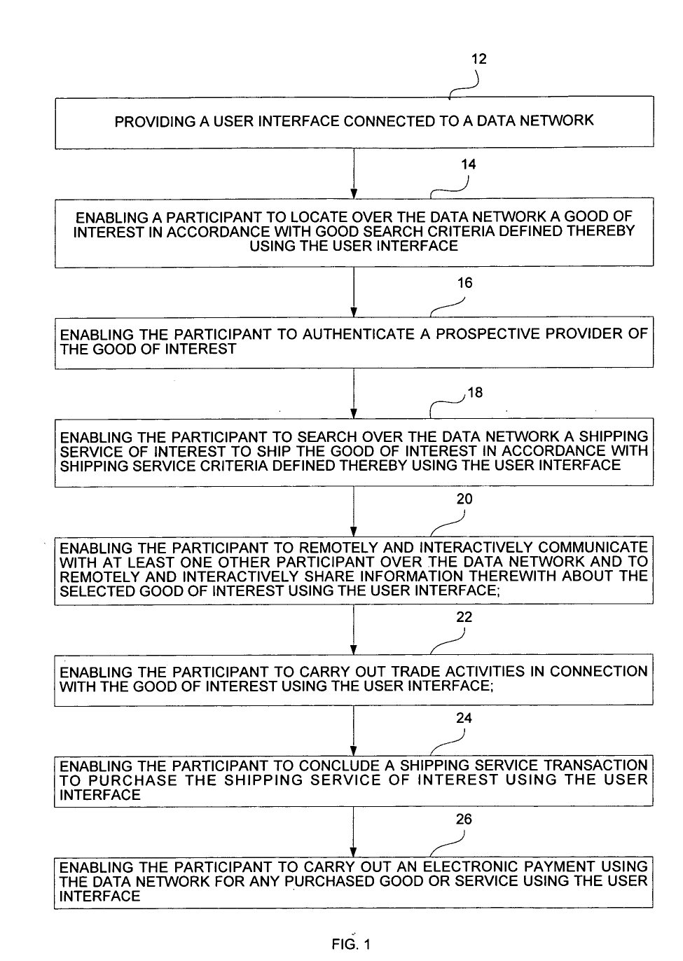

Referring to FIG. 1, there is provided a method for centralizing electronic activities associated with a good of interest over a data network. The method is essentially carried out by a mediator for centralizing electronic activities associated with a good of interest of a participant over the data network. First, the mediator provides a user interface connected to the data network for enabling the participant to carry out various electronic activities 12 using the same mediator. Once the participant is connected to the user interface provided by the mediator, the latter enables the participant to locate over the data network a good of interest in accordance with good search criteria defined thereby using the user interface 14. In order to define good search criteria, the user interface is adapted to receive data corresponding to good search criteria defining the parameters of the search to carry out. Once the good search criteria are defined, the mediator triggers a search over the data network and locates a list of goods corresponding to the defined good search criteria. The method is pursued when the participant selects one good of interest to purchase among the located goods.

In order for enabling the participant to locate over the data network a good of interest, the mediator uses the network for accessing and inquiring electronic market databases storing data corresponding to a list of goods offered for trade. In the preferred embodiment, the data network comprises the Internet and the electronic market databases comprise electronic market Web sites connected to the Internet. In the preferred embodiment, a copy of such data is stored into a database locally connected to the mediator's Web site.

Once a good of interest is selected by the participant, the mediator enables the participant to authenticate the good of interest 16. The authentication step is carried out automatically by the mediator without further action by the participant. The authentication process may take place during the posting of the good of interest on the mediator's Web site.

The participant can be a prospective purchaser of the good of interest. When it is the case, the process of enabling the prospective purchaser to authenticate the good of interest comprises accessing and inquiring an authentication database to ensure that the good of interest originates from an authorized provider.

In order for enabling the prospective purchaser to authenticate a prospective provider, the mediator accesses and inquires an authentication database using a unique identification code associated with the good of interest. In a preferred embodiment, the authentication database comprises, for each one of a plurality of goods, an identifier for uniquely identifying the good and at least one corresponding authorized good provider, wherein the inquiring comprises sending an inquiring request to the authentication database comprising a unique identification code associated with the good of interest and receiving thereof an indication of a successful authentication if a prospective provider corresponding to the unique identification code is comprised in the database.

The authentication database can be a local database locally connected to the mediator or a remote database connected to the data network. In this last case, the mediator uses the data network for accessing and inquiring the authentication database.

The participant can also be a prospective provider of the good of interest. In this case, the process of enabling the prospective provider to authenticate the good of interest comprises enabling the prospective provider to prove that he is an authorized provider of the good.

The participant can also be a carrier. In this case, the process of enabling the carrier to authenticate the good of interest comprises accessing and inquiring a jurisdictional database for retrieving jurisdictional information in order to inquire about legal aspects with respect to shipping the good of interest.

The participant can also be a manufacturer of the good of interest and the process of enabling the participant to authenticate the good of interest comprises enabling the manufacturer to certify that the good of interest has been manufactured thereby.

Once the good of interest is authenticated, the mediator enables the participant to search over the data network a shipping service of interest to ship the good of interest in accordance with shipping service criteria defined thereby using the user interface 18. In order to define shipping service criteria, the user interface is adapted to receive data corresponding to shipping service criteria. Once the shipping service criteria are defined, the mediator triggers a search over the data network and locates a list of available shipping services corresponding to the defined shipping service criteria. The method is pursued when the participant selects one shipping service of interest among the available shipping services to ship the good of interest. This step is preferably carried out when the participant is a prospective purchaser or a prospective provider of the good of interest.

In order for enabling the participant to obtain a shipping service of interest to ship the good of interest, the mediator uses the data network for accessing and inquiring shipping service databases connected to the network. The shipping database can be a local database locally connected to the mediator or a remote database connected to the data network. In this last case, the mediator uses the data network for accessing and inquiring the shipping database. In the main embodiment, the data network comprises the Internet and the shipping service databases comprise shipping service Web sites connected to the Internet.

The mediator also enables the participant to remotely and interactively communicate with at least one other participant over the data network and to remotely and interactively share information therewith about the selected good of interest 20.

In order for enabling the participant to remotely and interactively communicate with at least one other participant over the data network, the mediator displays the good of interest (or sets of items) in a screen interface displayed to the participant, enables the at least one other participant to access the screen interface displayed to the participant via the data network, and enables the at least one other participant to interactively communicate with the participant via the screen interface using the data network.

It should be understood that the steps of authenticating the good, locating a shipping service of interest and communicating with at least one other participant can be carried out interchangeably with no importance of order, and that the spirit of the technology is to create a synergy between various facilities to conduct electronic activities.

After authenticating a prospective provider of the good of interest, searching a shipping service of interest and, when needed, remotely and interactively communicating with at least one other participant over the network, if the participant desires to pursue in order to purchase the good of interest, the mediator enables the participant to use the user interface in order to carry out trade activities in connection with the good of interest 22.

When the participant is a prospective purchaser of the good of interest, the enabling the participant to carry out trade activities comprises enabling the participant to carry out at least one of reviewing trade activities related information, placing a barter offer, placing a purchase offer, placing a bid offer, concluding a barter transaction, concluding a purchase transaction and concluding a bid transaction. Trade activities can also comprise requesting a custom fees quote associated with the good of interest, or any other trade activity that could be conducted using the network.

When the participant is a prospective provider of the good of interest, the process of enabling the participant to carry out trade activities comprises enabling the participant to carry out at least one of posting the good for barter, posting the good for sale, posting the good for bid, concluding a barter transaction, concluding a purchase transaction and concluding a bid transaction.

When the participant is a carrier, the process of enabling the participant to carry out trade activities can comprise enabling the carrier to carry out at least one of posting a shipping service offer to ship the good of interest and concluding a shipping service transaction to ship the good of interest.

When the participant is a manufacturer of the good of interest, the process of enabling the manufacturer to carry out trade activities comprises enabling the manufacturer to certify that the good of interest has been manufactured thereby.

If the good of interest is purchased, the mediator enables the participant to conclude a shipping service transaction to purchase the shipping service of interest using the user interface 24. This step is preferably carried out between the carrier and the purchaser, but it can also be carried out by the provider and the carrier.

Finally, the mediator enables the participant to pay electronically the purchased good and service 26. In the preferred embodiment, such a payment may be carried out using third-party service available on the mediator's Web site.

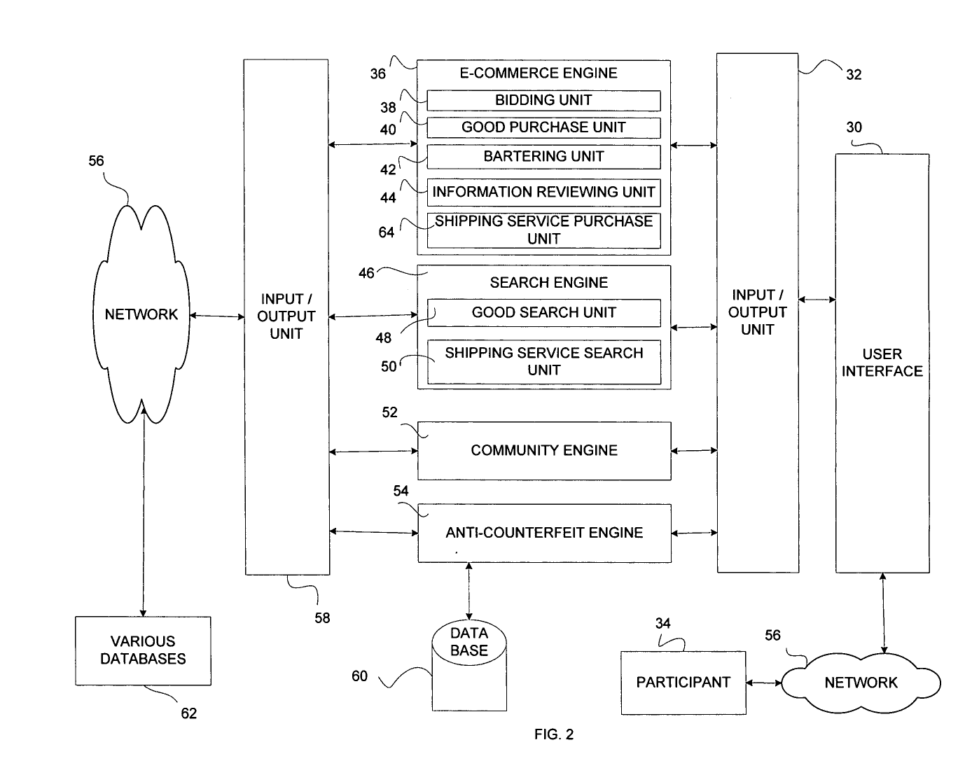

Referring to FIG. 2, there is provided a system for centralizing electronic activities associated with a good of interest over a data network. The system comprises a user interface 30, an E-commerce engine 36, a search engine 46, a community engine 52, an anti-counterfeit engine 54, a first input-output unit 32 and a second input-output unit 48.

The system can also comprise a mediator server connected to the data network; wherein the engines run. The engines can also be located anywhere over the data network, the engines being accessible to the mediator through the data network.

The user interface 30 is connected to a data network 56 for enabling a participant over the network to use the various facilities provided by the system. The mediator server could comprise a mediator Web site. In this case, the user interface 30 is connected to the mediator Web site and is accessible to the participant through the Internet.

The user interface 30 is further connected to the first input/output unit 32 for receiving data from the participant and transmitting it to the appropriate engine among the engines connected thereto, knowing the e-commerce engine 36, the search engine 46, the community engine 52 and to the anti-counterfeit engine 54.

The search engine 46 is connected to the user interface 30, via the first input-output unit 32, and to the data network 56, via the second input-output unit 58. The search engine 46 comprises a good search unit 48 for enabling the participant to locate over the data network a good of interest in accordance with good search criteria defined thereby using the user interface.

The search engine 46 could also comprise a shipping service search unit 50 for enabling the participant to search over the data network a shipping service of interest to ship the good of interest in accordance with shipping service criteria defined thereby using the user interface 30.

In the case where the mediator has an electronic market database, the latter is connected locally to the mediator server for locating a good of interest according the good search criteria defined by the participant.

The anti-counterfeit engine 54 is connected to the user interface 30, via the first input-output unit 32, and to the data network 56, via the second input-output unit 58, for enabling the participant to authenticate the good of interest.

The anti-counterfeit engine 54 is adapted to be connected to an authentication database 60. In a preferred embodiment, the authentication database comprises, for each one of a plurality of goods, an identifier for uniquely identifying the good and at least one corresponding authorized good provider, wherein the authenticating comprises sending an inquiring request to the authentication database comprising the unique identification code and receiving thereof an indication of a successful authentication if a prospective provider corresponding to the unique identification code is comprised in the database.

The authentication database 60 can be connected to the anti-counterfeit engine either locally or via the data network.

The community engine 52 is connected to the data network 56 for enabling the participant to remotely and interactively communicate with at least one other participant over the data network and to remotely and interactively share information therewith about the good of interest. A participant can be on another Web site which is connected to the mediator's site through the community engine.

The mediator Web site comprises a live shopping interface connected to the community engine for displaying to the participant the good of interest, and for enabling the at least one other participant to access the interface displayed to the participant via the data network and to interactively communicate with the participant via the data network.

The e-commerce engine 36 is connected to the user interface 30 and to the data network 56 for enabling the participant to carry out trade activities in connection with the good of interest.

The e-commerce engine 36 comprises at least one of an information reviewing unit 44, a bartering unit 42, a bidding unit 38 and a good purchase unit 40.

When the participant is a prospective purchaser, the information reviewing unit 44 enables the participant to review trade activities related information in connection with the good of interest. The bartering unit 42 enables the participant to place a barter offer and to conclude a barter transaction in connection with the good of interest. The bidding unit 38 enables the participant to place a bid offer and to conclude a bid transaction in connection with the good of interest. The good purchase unit 40 enables the participant to place a purchase offer and to conclude a purchase transaction in connection with the good of interest.

The e-commerce engine 36 can also comprise a shipping service purchase unit 64 for enabling the participant to conclude a shipping service transaction to purchase the shipping service of interest, a custom fees quoting module for providing a custom fee quote in association with the good of interest, or any other module for conducting an electronic trade activity.

When the participant is a prospective provider of the good of interest, the bartering unit 42 enables the participant to post the good for barter and to conclude a barter transaction in connection with the good of interest, the good purchase unit 40 enables the participant to post the good for sale and to conclude a purchase transaction, the bidding unit 38 enables the participant to post the good for bid and to conclude a bid transaction.

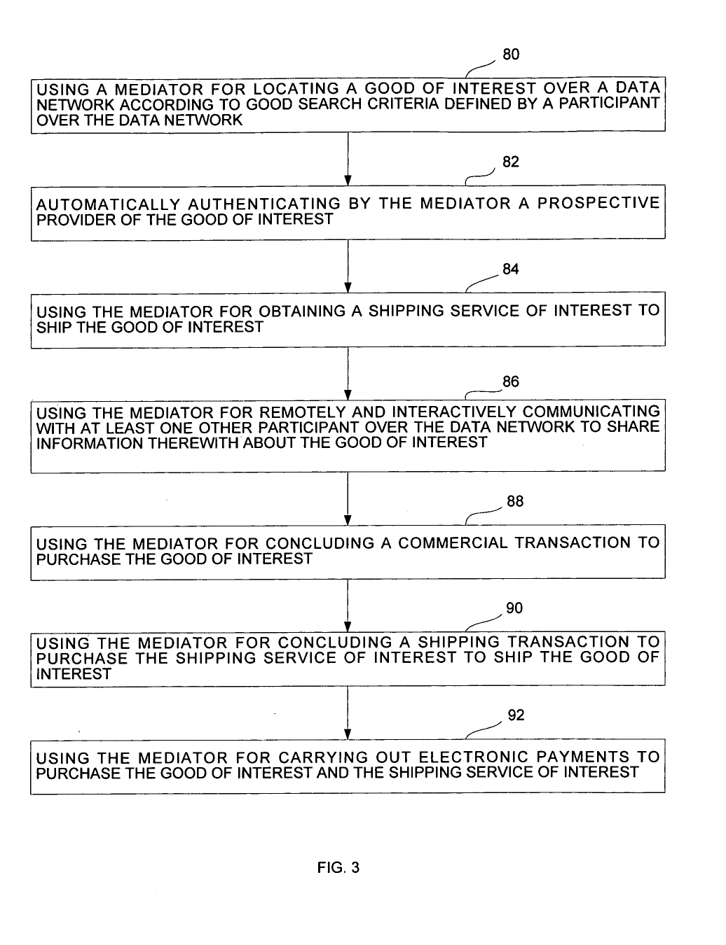

Referring to FIG. 3, there is provided a method for concluding, by a participant over a data network, commercial transactions using the data network. The method is carried out by using a unique mediator for facilitating conclusion of the commercial transactions.

First, the participant uses the mediator for locating a good of interest over the data network according to good search criteria defined by the participant over the data network 80. Once the good of interest is located, the mediator automatically authenticates the good of interest 82. The participant then uses the mediator for searching a shipping service of interest to ship the good of interest 84. In order to get a third party's opinion about the good of interest to purchase, the participant uses the mediator for remotely and interactively communicating with at least one other participant over the data network to share information therewith about the good of interest 86. If the participant has located the good of interest and an appropriate shipping service of interest and is positive to purchase the good of interest and the service of interest after having a third party's opinion, the participant uses the mediator for concluding a commercial transaction to purchase the good of interest 88 and for concluding a shipping transaction to purchase the shipping service of interest 90. Finally, the participant uses the mediator to carry out electronic payments in order to purchase the good and the service of interest 92.

It should be understood that certain steps of the above mentioned method can be carried out interchangeably, and that the spirit of the invention is to create a certain synergy between various electronic activities.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for centralizing electronic activities associated with a good of interest over a data network, the method comprising:
providing a user interface connected to the data network;
enabling a participant to locate over said data network a good of interest in accordance with good search criteria defined thereby using said user interface;
enabling said participant to authenticate said good of interest;
enabling said participant to remotely and interactively communicate with at least one other participant over said data network and to remotely and interactively share information therewith about said selected good of interest; and
enabling said participant to carry out trade activities in connection with said good of interest using said user interface.

2. The method as claimed in claim 1, wherein said enabling a participant to locate over said data network a good of interest comprises using said data network for accessing and inquiring electronic market databases storing data corresponding to a list of goods.

3. The method as claimed in claim 2, wherein said data network comprises the Internet and said electronic market databases comprise electronic market Web sites connected to the Internet.

4. The method as claimed in claim 3, wherein said participant is a prospective purchaser of said good of interest and said enabling said participant to carry out trade activities comprises enabling said participant to carry out at least one of reviewing trade activities related information, placing a barter offer, placing a purchase offer, placing a bid offer, concluding a barter transaction, concluding a purchase transaction and concluding a bid transaction.

5. The method as claimed in claim 4, wherein said enabling said prospective purchaser to authenticate said good of interest comprises accessing and inquiring an authentication database to ensure that said good of interest originates from an authorized provider.

6. The method as claimed in 5, wherein said authentication database comprises, for each one of a plurality of goods, an identifier for uniquely identifying said good and at least one corresponding authorized good provider, wherein said inquiring comprises sending an inquiring request to said authentication database comprising said unique identification code and receiving thereof an indication of a successful authentication if a prospective provider corresponding to said unique identification code is comprised in the database.

7. The method as claimed in claim 5, wherein said enabling said participant to remotely and interactively communicate with at least one other participant over said data network comprises displaying said good of interest in a screen interface displayed to said participant, enabling said at least one other participant to access said screen interface displayed to said participant via said data network, and enabling said at least one other participant to interactively communicate with said participant via said screen interface using said data network.

8. The method as claimed in claim 5 further comprising:
enabling said participant to search over said data network a shipping service of interest to ship said good of interest in accordance with shipping service criteria defined thereby using said user interface; and
enabling said participant to conclude a shipping service transaction to purchase said shipping service of interest using said user interface.

9. The method as claimed in claim 8, wherein said enabling said participant to search over said data network a shipping service of interest to ship said good of interest comprises using said data network for accessing and inquiring shipping service databases.

10. The method as claimed in claim 9, wherein said shipping service databases comprise shipping service Web sites connected to the Internet.

11. The method as claimed in claim 10 further comprising enabling said participant to carry out an electronic payment using said user interface.

12. The method as claimed in claim 3, wherein said participant is a prospective provider of said good of interest and said enabling said participant to carry out trade activities comprises enabling said participant to carry out at least one of posting said good for barter, posting said good for sale, posting said good for bid, concluding a barter transaction, concluding a purchase transaction and concluding a bid transaction.

13. The method as claimed in claim 12, wherein said enabling said prospective provider to authenticate said good of interest comprises enabling said prospective provider to prove that he is an authorized provider of said good.

14. The method as claimed in claim 13, wherein said enabling said participant to remotely and interactively communicate with at least one other participant over said data network comprises displaying said good of interest in a screen interface displayed to said participant, enabling said at least one other participant to access said screen interface displayed to said participant via said data network, and enabling said at least one other participant to interactively communicate with said participant via said screen interface using said data network.

15. The method as claimed in claim 13 further comprising:
enabling said participant to search over said data network a shipping service of interest to ship said good of interest in accordance with shipping service criteria defined thereby using said user interface; and
enabling said participant to conclude a shipping service transaction to purchase said shipping service of interest using said user interface.

16. The method as claimed in claim 15, wherein said enabling said participant to search over said data network a shipping service of interest to ship said good of interest comprises using said data network for accessing and inquiring shipping service databases.

17. The method as claimed in claim 16, wherein said shipping service databases comprise shipping service Web sites connected to the Internet.

18. The method as claimed in claim 17 further comprising enabling said participant to carry out an electronic payment using said user interface.

19. The method as claimed in claim 3, wherein said participant is a carrier and said enabling said participant to carry out trade activities comprises enabling said carrier to carry out at least one of posting a shipping service offer to ship said good of interest and concluding a shipping service transaction to ship said good of interest.

20. The method as claimed in claim 19, wherein said enabling said carrier to authenticate said good of interest comprises accessing and inquiring a jurisdictional database for retrieving jurisdictional information in order to inquire about legal aspects with respect to shipping said good of interest.

21. The method as claimed in claim 20, wherein said enabling said participant to remotely and interactively communicate with at least one other participant over said data network comprises displaying said good of interest in a screen interface displayed to said participant, enabling said at least one other participant to access said screen interface displayed to said participant via said data network, and enabling said at least one other participant to interactively communicate with said participant via said screen interface using said data network.

22. The method as claimed in claim 21 further comprising enabling said participant to carry out an electronic payment using said user interface.

23. The method as claimed in claim 3, wherein said participant is a manufacturer of said good of interest and said enabling said participant to authenticate said good of interest and said enabling said manufacturer to carry out trade activities comprises enabling said manufacturer to certify that said good of interest has been manufactured thereby.

24. The method as claimed in claim 23, wherein said enabling said participant to remotely and interactively communicate with at least one other participant over said data network comprises displaying said good of interest in a screen interface displayed to said participant, enabling said at least one other participant to access said screen interface displayed to said participant via said data network, and enabling said at least one other participant to interactively communicate with said participant via said screen interface using said data network.

25. The method as claimed in claim 24 further comprising enabling said participant to carry out an electronic payment using said user interface.

26. A system for centralizing electronic activities associated with a good of interest over a data network, the system comprising:
a user interface connected to said data network;
a search engine connected to said user interface and to said data network, said search engine comprising a good search unit for enabling a participant to locate over said data network a good of interest in accordance with good search criteria defined thereby using said user interface;
an anti-counterfeit engine connected to an authentication database for enabling said participant to authenticate said good of interest;
a community engine connected to said data network for enabling said participant to remotely and interactively communicate with at least one other participant over said data network and to remotely and interactively share information therewith about said good of interest; and
an e-commerce engine connected to said user interface and to said data network for enabling said participant to carry out trade activities in connection with said good of interest.

27. The system as claimed in claim 26, wherein:
said search engine further comprises a shipping service search unit for enabling said participant to search over said data network a shipping service of interest to ship said good of interest in accordance with shipping service criteria defined thereby using said user interface; and
said e-commerce engine further comprises a shipping service purchase unit for enabling said participant to conclude a shipping service transaction to purchase said shipping service of interest.

28. The system as claimed in claim 27 wherein said e-commerce engine comprises at least one of an information reviewing unit, a bartering unit, a bidding unit and a purchase unit.

29. The system as claimed in claim 28, wherein said participant is a prospective purchaser of said good of interest and said information reviewing unit enables said participant to review trade activities related information in connection with said good of interest, said bartering unit enables said participant to place a barter offer and to conclude a barter transaction in connection with said good of interest, said bidding unit enables said participant to place a bid offer and to conclude a bid transaction in connection with said good of interest, and said purchase unit enables said participant to place a purchase offer and to conclude a purchase transaction in connection with said good of interest.

30. The system as claimed in claim 29 further comprising a mediator server connected to said data network; wherein said engines run on said mediator server.

31. The system as claimed in claim 30, wherein said mediator server comprises a mediator Web site and said user interface is connected to said mediator Web site.

32. The system as claimed in claim 31 further comprising a mediator database storing data corresponding to a list of goods and services offered for trade, wherein said mediator database is connected to said search engine.

33. The system as claimed in claim 32, wherein said anti-counterfeit engine is adapted to be connected, via said data network, to a database comprising, for each one of a plurality of goods, an identifier for uniquely identifying said good and at least one corresponding authorized good provider, wherein said authenticating comprises sending an inquiring request to said authentication database comprising a unique identification code associated with said good of interest and receiving thereof an indication of a successful authentication if a prospective provider corresponding to said unique identification code is found in the database.

34. The system as claimed in claim 33 wherein said mediator Web site comprises a live shopping interface connected to said community engine for displaying to said participant said good of interest, and for enabling said at least one other participant to access said interface displayed to said participant via said data network and to interactively communicate with said participant using said data network.

35. The system as claimed in claim 34, wherein said e-commerce engine further comprises an electronic payment unit for enabling said participant to carry out electronic payments to purchase said good of interest and said shipping service of interest.

36. The system as claimed in claim 28, wherein said participant is a prospective provider of said good of interest and said bartering unit enables said participant to post said good for barter and to conclude a barter transaction in connection with said good of interest, said purchase unit enables said participant to post said good for sale and to conclude a purchase transaction, said bidding unit enables said participant to post said good for bid and to conclude a bid transaction.

37. The system as claimed in claim 36 further comprising a mediator server connected to said data network; wherein said engines run on said mediator server.

38. The system as claimed in claim 37, wherein said mediator server comprises a mediator Web site and said user interface is connected to said mediator Web site.

39. The system as claimed in claim 38 further comprising a mediator database storing data corresponding to a list of goods and services offered for trade, wherein said mediator database is connected to said search engine.

40. The system as claimed in claim 39, wherein said mediator Web site comprises a live shopping interface connected to said community engine for displaying to said participant said good of interest, and for enabling said at least one other participant to access said interface displayed to said participant via said data network and to interactively communicate with said participant using said data network.

41. The system as claimed in claim 40, wherein said e-commerce engine further comprises an electronic payment unit for enabling said participant to carry out electronic payments to purchase said good of interest and said shipping service of interest.

42. A method for concluding a commercial transaction over a data network, the method comprising:
using a mediator for locating a good of interest over said data network according to good search criteria defined by a participant over said data network;
automatically authenticating by said mediator said good of interest;
using said mediator for remotely and interactively communicating with at least one other participant over said data network to share information therewith about said good of interest; and
using said mediator for concluding a commercial transaction to purchase said good of interest.

43. The method as claimed in claim 42 further comprising:
using said mediator for obtaining a shipping service of interest to ship said good of interest; and
using said mediator for concluding a shipping transaction to purchase said shipping service of interest.

44. A method as claimed in claim 43, further comprising using said mediator for enabling said participant to carry out electronic payments to purchase said good of interest and said shipping service of interest.
